(19) United States
(12) Patent Application Publication
(10) Pub. No.: US 2002/0098002 A1
(43) Pub. Date: Jul. 25, 2002

(54) Zoom lens decode control for camera

(76) Inventors: De-Jeng Li, Chang Hua (TW); Hui-Ying Wang, Taichung (TW); Cheng-Yu Lin, Taichung Hsien (TW); Chun-Chien Chen, Taichung (TW)

Correspondence Address: BROWDY AND NEIMARK, P.L.L.C., 624 NINTH STREET, NW, SUITE 300, WASHINGTON, DC, 20001-5303, US

(21) Appl. No.: 09/767,906

(22) Filed: Jan. 24, 2001

(51) Int. Cl. G03B 17/00

(52) U.S. Cl. 396/543

(57) ABSTRACT

A zoom lens decode control includes a circuit board, the circuit board having a first annular contact circuit, a second annular contact circuit and an annular counting circuit concentrically arranged around an axle hole thereof, the annular counting circuit having radially extended protruding counting tips, and an electric brush adapted to be rotated with a gear and moved over the circuit board, the electric brush having three protruded contacts adapted to contact the first annular contact circuit, the second annular contact circuit and the counting tips of the counting circuit for causing a microprocessor to control the angle and direction of rotation of a zoom lens control motor subject to the amount and direction of the rotary motion of the gear.

### BACKGROUND OF THE INVENTION

The present invention relates to the control of the zoom lens of a camera and, more particularly to a zoom lens decode control for camera, which reduces possible image mapping error.

The focusing of the lens of a camera directly affects the clearness of the picture taken. The focusing of the zoom lens of a regular camera is adjusted step by step. When the object is taken between two control steps, the image obtained is vague. The more the number of the controllable control steps the less the image error will be. FIGS. 1 and 2 show a zoom lens decode control according to the prior art. This structure of zoom lens decode control comprises a circuit board 10, and an electric brush 13 rotated with a gear and moved over the circuit board 10. The circuit board 10 comprises one first conductive plate 11, four second conductive plates 12. The electric brush 13 has four contacts. When rotating the electric brush 13, the contacts of the electric brush 13 are moved over the conductive plates 11 and 12 to output different signals to a microprocessor, causing the microprocessor to control the angle and direction of rotation of a zoom control motor subject to the direction and amount of movement of the electric brush (the gear). This structure of zoom lens decode control is still not satisfactory in function. In order to increase the number of control steps, the number of the second conductive plates must be relatively increased. However, increasing the number of the second conductive plates results in heavy size and high cost. Because the number of the second conductive plates is limited to a limited number, an image mapping error may occur, resulting in a vague image.

### SUMMARY OF THE INVENTION

The present invention has been accomplished to provide a zoom lens decode control, which eliminates the aforesaid drawbacks. It is one object of the present invention to provide a zoom lens decode control, which provides a big number of control steps to effectively reduces possible image error. It is another object of the present invention to provide a zoom lens decode control, which uses a counting method to control the stroke of the movement of the zoom lens accurately. According to the present invention, the zoom lens decode control comprises a circuit board, the circuit board comprising a first annular contact circuit, a second annular contact circuit concentrically arranged around the first annular contact circuit, and an annular counting circuit concentrically arranged around the second annular contact circuit, the annular counting circuit comprising a plurality of protruding counting tips; an electric brush rotatably disposed in contact with the circuit board, the electric brush comprising a first protruded contact disposed in contact with the first contact circuit, a second protruded contact adapted to contact the second contact circuit upon rotary motion of the electric brush relative to the circuit board, and a third protruded contact adapted to contact the counting tips of the counting circuit one after another upon rotary motion of the electric brush relative to the circuit board for producing counting signal to a microprocessor in the camera for causing the microprocessor to control the angle and direction of rotation of a zoom lens control motor of the camera subject to the amount and direction of the rotary motion of the electric brush.

### BRIEF DESCRIPTION OF THE DRAWINGS

FIG. 1 is an exploded view of a zoom lens decode control according to the prior art.

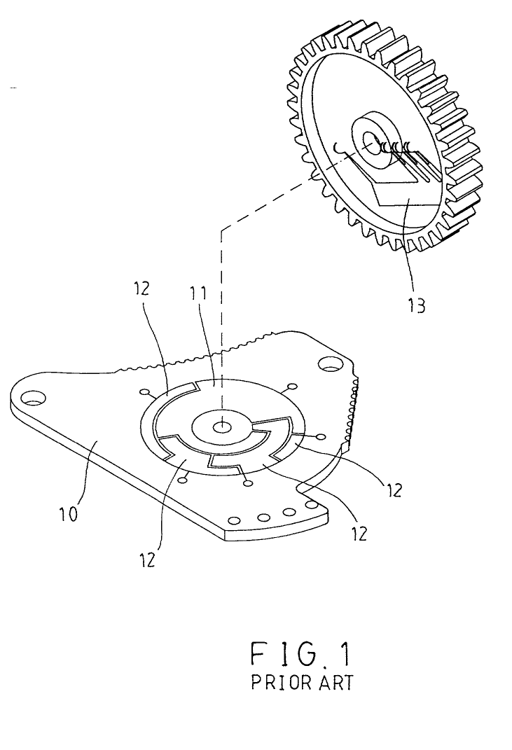

FIG. 2 is a front view of the circuit board of the zoom lens decode control according to the prior art.

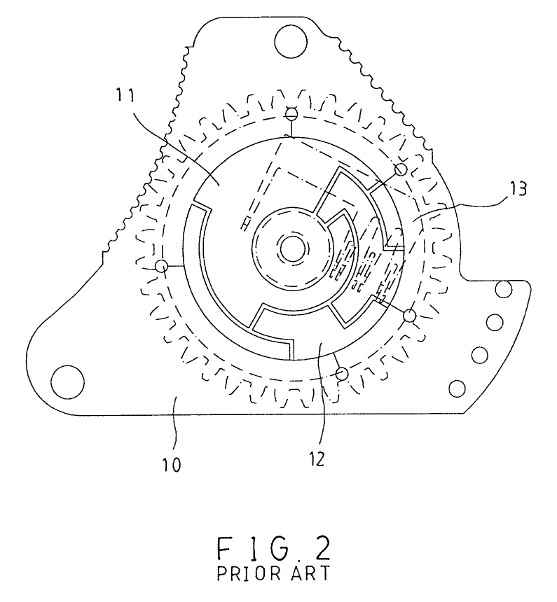

FIG. 3 is an exploded view of a zoom lens decode control according to the present invention.

FIG. 4 is a front view of the circuit board of the zoom lens decode control according to the present invention.

### DETAILED DESCRIPTION OF THE PREFERRED EMBODIMENT

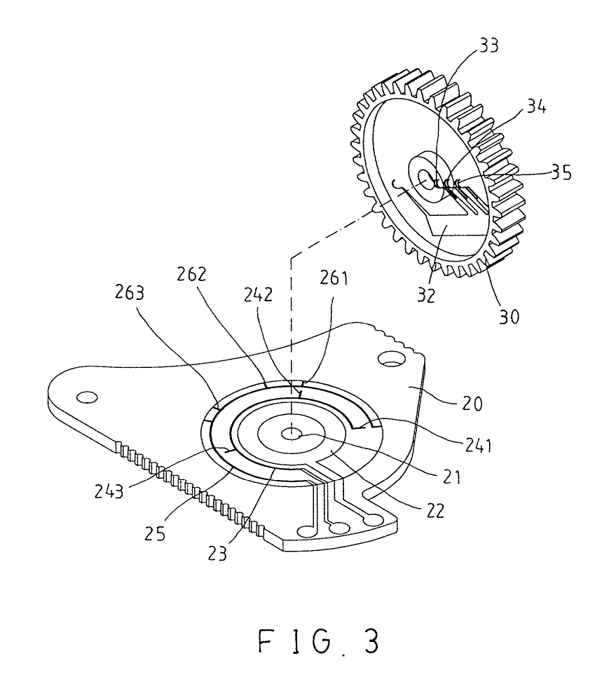

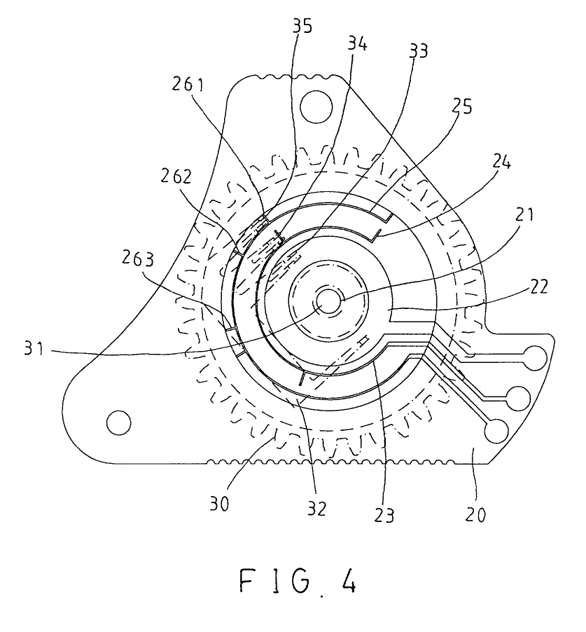

Referring to FIGS. 3 and 4, a zoom lens decode control is installed in the inside of a camera, comprising a circuit board 20, and a rotary member 30. The circuit board 20 has an axle hole 21 through the substrate thereof. Further, the circuit board 20 comprises a first contact circuit 22 of annular shape concentrically arranged around the axle hole 21, a second contact circuit 23 of annular shape concentrically arranged around the first contact circuit 22, and a counting circuit 25 of annular shape concentrically arranged around the second contact circuit 23. The second contact circuit 23 has a plurality of outwardly extended protruding contact tips 24. The counting circuit 25 has a plurality of radially extended protruding counting tips 26. The first contact circuit 22, the second contact circuit 23 and the counting circuit 25 have a respective contact electrically connected to an external circuit. The rotary member 30 according to the present preferred embodiment is a gear. The gear 30 comprises a gear shaft 31 pivoted to the axle hole 21 of the circuit board 20. An electric brush 32 is provided at one side of the gear 30. The electric brush 32 has three protruded contacts 33, 34 and 35 adapted to contact the first contact circuit 22, the second contact circuit 23 and the counting tips 26 of the counting circuit 25 respectively.

When rotating the gear 30, the electric brush 32 is moved with the gear 30. At the initial stage after rotation of the electric brush 32 with the gear 30, the first protruded contact 33 of the electric brush 32 contacts the first contact circuit 22, and the second protruded contact 34 of the electric brush 32 contacts the first outwardly extended protruding contact tip 241 of the second contact circuit 23 to form a loop and to output a signal to the internal microprocessor of the camera, causing the camera to be shifted from the off status to the stand-by status. When continuously rotating the gear 30, the second protruded contact 34 of the electric brush 32 is moved into contact with the second outwardly extended protruding contact tip 242 of the second contact circuit 23 to form another loop and to output a signal to the internal microprocessor of the camera, informing the microprocessor of the start point of counting (lower limit position). When continuously rotating the gear 30, the third protruded contact 35 of the electric brush 32 is moved into contact with one counting tip 261 of the counting circuit 25 to form a loop and to output a signal to the microprocessor, causing the microprocessor to start counting.

When rotating the gear 30 counter-clockwise, the third protruded contact 35 of the electric brush 32 is moved into contact with the counting tips 261, 263, 263 of the counting circuit 25 one after another. Upon contact of the third protruded contact 35 of the electric brush 32 with each counting tip 26 of the counting circuit 25, a respective loop is formed, and a counting signal is outputted to the microprocessor, causing the microprocessor to count up, and to control the angle of rotation of the motor subject to its counting result, and therefore the position of the lens is accurately controlled. The more the number of the counting tips 26 is, the more the number of steps of the stroke of the lens will be. When the second protruded contact 34 of the electric brush 32 contacts the third outwardly extended protruding contact tip 243 of the second contact circuit 23, a signal is outputted to the microprocessor, informing the microprocessor of the finish point of the counting (upper limit position), and therefore the microprocessor stops from counting.

On the contrary, when rotating the gear 30 clockwise, the third protruded contact 35 of the electric brush 32 is moved into contact with the counting tips 26 of the counting circuit 25 one after another. Upon each contact, a loop is formed, and a counting signal is outputted to the microprocessor, causing the microprocessor to count down, so as to further control the angle of rotation of the motor in the reversed direction, and therefore the position of the lens is controlled.

It is to be understood that the drawings are designed for purposes of illustration only, and are not intended for use as a definition of the limits and scope of the invention disclosed.

What the invention claimed is:

1. A zoom lens decode control installed in a camera to control the position of a zoom lens, comprising:
a circuit board, said circuit board comprising a first annular contact circuit, a second annular contact circuit concentrically arranged around said first annular contact circuit, and an annular counting circuit concentrically arranged around said second annular contact circuit, said annular counting circuit comprising a plurality of protruding counting tips;
an electric brush rotatably disposed in contact with said circuit board, said electric brush comprising a first protruded contact disposed in contact with said first contact circuit, a second protruded contact adapted to contact said second contact circuit upon rotary motion of said electric brush relative to said circuit board, and a third protruded contact adapted to contact the counting tips of said counting circuit one after another upon rotary motion of said electric brush relative to said circuit board for producing counting signal to a microprocessor in said camera for causing said microprocessor to control the angle and direction of rotation of a zoom lens control motor of said camera subject to the amount and direction of the rotary motion of said electric brush.

2. The zoom lens decode control of claim 1, wherein said circuit board comprises an axle hole, and said first contact circuit, said second contact circuit and said counting circuit are concentrically arranged around said axle hole.

3. The zoom lens decode control of claim 2, wherein the protruding counting tips of said counting circuit are extended radially outwards.

4. The zoom lens decode control of claim 3 further comprising a rotary member pivoted to the axle hole of said circuit board and adapted to hold said electric brush and to move said electric brush relative to said circuit board.

5. The zoom lens decode control of claim 4, wherein said rotary member is a gear having a gear shaft pivoted to the axle hole of said circuit board.
